(19) United States
(12) Patent Application Publication
(10) Pub. No.: US 2014/0015259 A1
(43) Pub. Date: Jan. 16, 2014

(54) METHODS AND APPARATUS FOR INHIBITING MOVEMENT OF A DOOR

(71) Applicant: Michael Harrigan, Leesburg, VA (US)

(72) Inventor: Michael Harrigan, Leesburg, VA (US)

(21) Appl. No.: 13/545,341

(22) Filed: Jul. 10, 2012

(51) Int. Cl. E05C 1/06; B23P 11/00

(52) U.S. Cl. 292/156; 292/137; 29/428

(57) ABSTRACT

A locking device includes a body portion and a flange portion. The body portion is configured to slidably engage a horizontal portion of a door. The flange portion extends from an edge of the body portion such that the flange can engage at least a portion of a structure adjacent to the door.

### BACKGROUND

The embodiments described herein relate to limiting access through a door and more specifically to apparatus slidably disposed about a door to selectively inhibit movement of the door.

A span of time exists in the development of a child where is it is often desirable for a parent to protect a child by limiting his or her ability to open doors. This has given rise to many known devices configured to make the task of opening a door beyond the cognitive capacity of a young child. In some known instances, a device can be placed beyond a child's reach, thereby preventing the child from disengaging the device (e.g., move from a locked to unlocked configuration).

However, many known devices do not adequately address certain design considerations such as, for example, portability, ease of installation, ease of use, or the like. For example, some known devices are configured to be mounted to a door via a mechanical fastener, an adhesive, and/or a clamping mechanism. In such instances, the portability of the known devices is limited (e.g., is not easily removed for implementation on another door). Furthermore, the removal of some known devices can lead to unsightly holes, marks, blemishes, or dents left on the door or door frame. In some instances, known devices are mounted to a door such that the devices are only accessible from one side of the door. In such instances, the known devices can undesirably act to prevent an adult's passage from the other side of the door. In other instances, known devices are designed for a specific door style, size, or opening method (e.g., either opening by swinging a door toward or away from the person opening the door), thereby limiting the application of the known devices.

Thus, a need exists for improved apparatus and methods for selectively inhibiting the opening of a door.

### SUMMARY

Apparatus and methods for selectively preventing and/or inhibiting the opening of a door are described herein. In some embodiments, a locking device includes a body portion and a flange portion. The body portion is configured to slidably engage a horizontal portion of a door. The flange portion extends from a surface of the body portion such that the flange can engage at least a portion of a structure adjacent to the door.

### BRIEF DESCRIPTION OF THE DRAWINGS

FIGS. 1 and 2 are schematic illustrations of a locking device according to an embodiment, in a first configuration and a second configuration, respectively.

FIG. 3 is a side view illustration of a locking device according to an embodiment.

FIG. 4 is a perspective view illustration of the locking device of FIG. 3.

FIG. 5 is a perspective view illustration of a locking device according to an embodiment.

FIG. 6 is a perspective view illustration of a locking device according to an embodiment.

FIG. 7 is a side view illustration of a locking device according to an embodiment.

FIG. 8 is a flowchart illustrating a method for selectively preventing the opening of a door.

### DETAILED DESCRIPTION

Apparatus and methods for selectively preventing the opening of a door are described herein. In some embodiments, a locking device includes a body portion and a flange portion. The body portion is configured to slidably engage a horizontal portion of a door. The flange portion extends from an edge of the body portion such that the flange can engage at least a portion of a structure adjacent to the door.

In some embodiments, a locking device includes a body portion and a flange portion. The body portion includes a first vertical portion configured to engage a first side of a door, a second vertical portion configured to engage a second side of the door, and a horizontal portion, disposed therebetween, configured to engage a horizontal portion of the door. The flange portion extends from an edge of the body portion such that the flange can engage a structure adjacent a vertical edge of the door when the door is in a completely closed position.

In some embodiments, a method for selectively preventing the opening of a door includes removably coupling a locking device to a horizontal portion of the door without attaching the locking device thereto. The method further includes sliding the locking device from a first position in which the locking device does not inhibit movement of the door to a second position in which a flange portion of the locking device engages a structure adjacent the door to inhibit movement of the door.

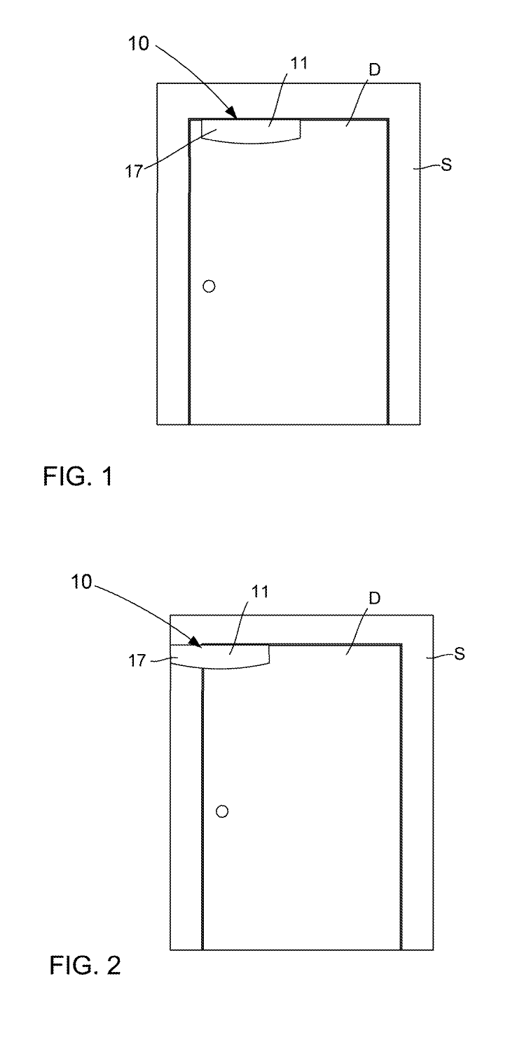

FIGS. 1 and 2 are schematic illustrations of a locking device 10 according to an embodiment, in a first configuration and a second configuration, respectively. The locking device 10 can be formed from any suitable material, for example, a metal, a plastic, a composite, and/or any combination thereof. The locking device 10 includes a body portion 11 and a flange portion 17. The body portion 11 is configured to be movably disposed about a portion of a door D. For example, in some embodiments, the body portion 11 of the locking device 10 can be substantially C-shaped. Similarly stated, the body portion 11 can include a first vertical leg, a second vertical leg, and a horizontal leg disposed therebetween. In this manner, the body portion 11 of the locking device can be movably disposed about a top portion of the door D (e.g., a horizontal portion such as a top surface) without any portion of the device 10 coupled to the door D (e.g., screwed, adhered, etc.). In some embodiments, the device 10 can be positioned on the floor and can engage the bottom horizontal surface of the door D.

The body portion 11 can be any suitable shape, size, or configuration. For example, in some embodiments, the body portion 11 can be configured to be disposed about a standard width door (e.g., 1.375 inch door). In such embodiments, the body portion 11 can be configured such that a desired tolerance exists between inner surfaces of the body portion 11 (e.g., an inner surface of a first vertical leg and an inner surface of a second vertical leg) and vertical surfaces of the door D. In other embodiments, the width of the locking device 10 can be adjustable to fit any suitable door width. In other words, the width of the horizontal portion can be significantly greater than a conventional door and adjusted to fit the door using spacers on an interior portion of the body portion 11 (i.e., spacers placed between the body portion 11 and the door D).

While not shown in FIG. 1, in some embodiments, the body portion 11 can include any suitable feature configured to increase the ergonomics of the locking device 10. For example, in some embodiments, the body portion 11 can include a handle, a protrusion, a rail, a wand, a groove, or the like. Moreover, any of the features can be configured to extend from the body portion 11 in a vertical direction toward the ground such that the accessibility of the locking device 10 is increased. For example, in some embodiments, a handle can extend from the body portion 11 a sufficient distance such that the locking device 10 can be reached by most adults and/or older children. Additionally, the body portion 11 and or any of the ergonomic features described can include any suitable surface finish or texture. In this manner, the locking device 10 can be engaged by a user (e.g., an adult or young adult) and moved between the first configuration (FIG. 1) and the second configuration (FIG. 2), as described in further detail herein.

The flange portion 17 of the locking device 10 is configured to extend from an end of the body portion 11 to engage a structure S adjacent to the door D when the locking device 10 is placed in the second configuration. In some embodiments, the flange portion 17 can extend from one or both of the vertical legs of the body portion 11. In other embodiments, the flange portion 17 can extend from the horizontal leg. In some embodiments, the flange portion 17 is monolithically formed with the body portion 11. For example, in some embodiments, the locking device 10 can be configured such that the flange portion 17 extends in a doglegged manner. Similarly stated, a first leg of the flange portion 17 (not shown in FIGS. 1 and 2) can extend perpendicularly from the first vertical leg and/or the second vertical leg of the body portion 11 and a second leg (not shown) can extend substantially parallel to the first vertical leg or the second vertical leg of the body portion 11. In still other embodiments, the flange portion 17 can extend horizontally from a bottom portion of the first vertical leg and/or the second vertical leg. In such embodiments, the flange portion 17 can extend beyond the edge of the first vertical leg and/or the second vertical leg and can include an extension (e.g., substantially parallel to the vertical legs) configured to engage the structure S.

In some embodiments, the flange portion 17 can be coupled to the body portion 11 (e.g., via a mechanical fastener, an adhesive, and/or any other suitable coupling method). In such embodiments, the flange portion 17 can be coupled to the body portion 17 such that the flange portion 17 can be moved relative to the body portion 11. In this manner, the flange portion 17 can be configured relative to the body portion 11 to engage a structure (e.g., a door frame, or the like) of any suitable size.

In use, the locking device 10 can be engaged by a user (e.g., an adult or young adult) and slid, relative to the door D, such that the flange portion 17 extends beyond a portion of the structure S, as shown in FIG. 2. In some embodiments, one or more inner surfaces of the body portion 11 can include one or more bearings, one or more rollers, and/or the like that can be configured to facilitate the sliding of the locking device 10 relative to the door D. In this manner, the flange portion 17 can be configured to engage the structure S adjacent to a vertical edge of the door D when the door D is in the completely closed position (e.g., the door D is latched such that a knob or handle needs be engaged to move the door D from the closed position). Thus, when in the second configuration, the flange portion 17 can engage the structure S to inhibit movement of the door D. Moreover, the locking device 10 can be moved from the second configuration toward the first configuration such that the flange portion 17 disengages the structure S, thereby no longer inhibiting movement of the door. As shown in FIGS. 1 and 2, with the locking device 10 disposed about the horizontal portion (e.g., the top surface) of the door, the locking device 10 is placed out of the reach of children and thus, prevents a child from opening the door D.

In some embodiments, the structure S adjacent the door D is a door frame or other fixed structure unrelated to the device. In other words, the locking device 10 engages a pre-existing structure surrounding the door that the device is intended to lock (i.e., the structure defines at least a portion of the opening in which the door is positioned). In some embodiments, the door D is a conventional door (i.e., a door to a room, an office, a pantry, a utility closet, etc.). In other embodiments, the door D is a cabinet door, a gate, a drawer, a garage door, etc. Regardless of the configuration of the door, the locking device 10 is configured to be a single component that is removably coupled to the door without physical attachment mechanisms or accessories. In some embodiments, the flange includes structure to enhance the engagement with the structure S. For example, the flange can include a pad, to increase the friction between the flange and the structure. The flange can also be configured to include a rough or jagged surface to enhance the engagement with the structure S. In some embodiments, flange portion 17 can be configured to extend into a portion of the structure S. In such embodiments a slot could be previously defined in the structure S, or can be defined by the flange portion 17. For example, the flange portion 17 can have a sharpened tip that penetrates at least a portion of structure S. In such a configuration, the flange portion 17 can extend from any portion of the body such that the flange portion 17 penetrates the structure S.

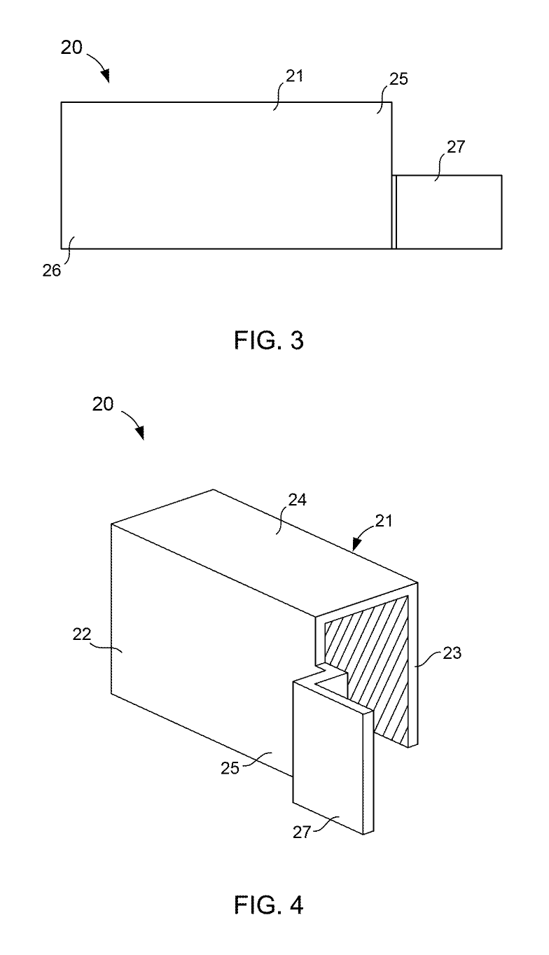

While flange portion 17 is shown in FIGS. 1 and 2 as having a substantially similar height as the body portion 11, in some embodiments, a flange portion can be substantially smaller than a body portion of a locking device. For example, FIGS. 3 and 4 illustrate a locking device 20 according to an embodiment. The locking device 20 includes a body portion 21 and a flange portion 27. The body portion 21 includes a first vertical portion 22 (also referred to as “first vertical leg”), a second vertical portion 23 (also referred to as “second vertical leg”), and a horizontal portion 24 (also referred to as “horizontal leg”). More specifically, the first vertical leg 22 and the second vertical leg 23 can be configured such that the horizontal leg 24 has a width configured to substantially correspond to the width of a door (not shown in FIGS. 3 and 4). Furthermore, the first vertical leg 22 and the second vertical leg 23 can extend from the horizontal leg 24 to have any suitable length or width. In some embodiments, the flange portion can be wider than the body portion.

The flange portion 27 is configured to extend from an end portion 25 of the body portion 21. For example, as shown in FIG. 4, the flange portion 27 can extend from an edge of the end portion 25 in a doglegged shape. Similarly stated, a first leg of the flange portion 27 can extend perpendicularly from the first vertical leg 22 of the body portion 21 and a second leg can extend substantially parallel to the first vertical leg 22 of the body portion 21. The flange portion 27 can be any suitable size and can extend from the end portion 25 any suitable distance. For example, the flange portion 27 can be configured such that the size or shape substantially corresponds to a structure adjacent to the door (e.g., the door frame or an additional door). Furthermore, the flange portion 27 can have a height that is substantially less than the height of the first vertical leg 22. In this manner, the locking device 20 can be disposed about a door and moved between a first configuration in which the locking device 20 does not inhibit movement of the door and a second configuration in which the flange portion 27 of the locking device engages a structure adjacent to the door to inhibit the movement of the door, as described above.

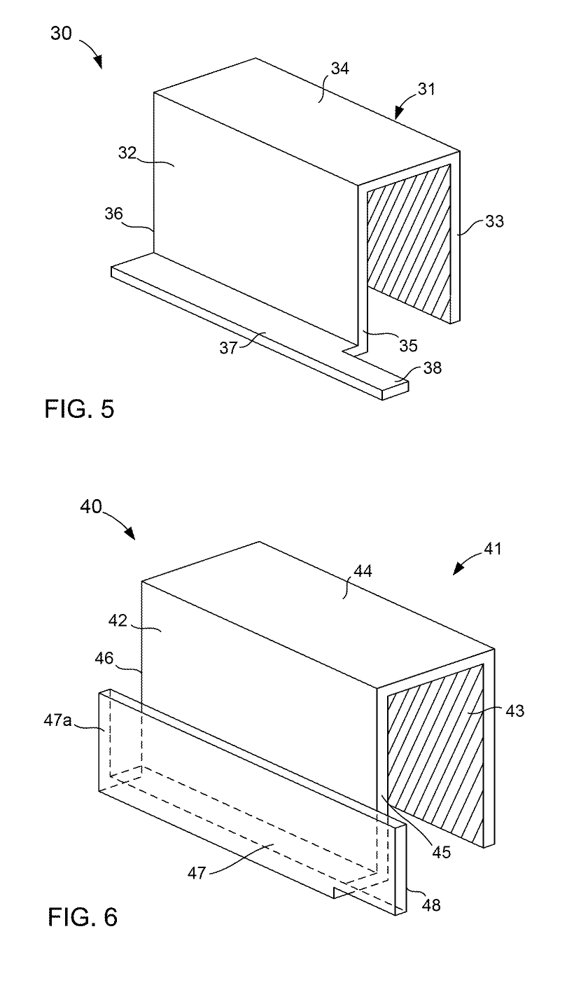

While the flange portion 27 is shown in FIGS. 3 and 4 as extending in a doglegged shape from the body portion 21, in some embodiments, a locking device can include a flange portion that extends from a body portion in any suitable manner For example, FIG. 5 illustrates a locking device 30 according to an embodiment. The locking device 30 includes a body portion 31 and a flange portion 37. The body portion 31 includes a first vertical portion 32 (also referred to as “first vertical leg”), a second vertical portion 33(also referred to as “second vertical leg”), and a horizontal portion 34 (also referred to as “horizontal leg”). More specifically, the first vertical leg 32 and the second vertical leg 33 can be configured such that the horizontal leg 34 has a width configured to substantially correspond to the width of a door (not shown in FIG. 5). The flange portion 37 is configured to extend perpendicularly from the first vertical leg 32 and includes an end portion 38 configured to extend beyond an end portion 35 of the body portion 31. In this manner, an edge of the end portion 38 of the flange 37 can engage a structure adjacent to a door to selectively inhibit movement of the door, as described herein.

While the flange 37 is specifically described above as engaging the structure adjacent to the door with the edge, in other embodiments, a locking device can be configured such that any suitable portion of a flange engages the structure adjacent to the door. For example, FIG. 6 illustrates a locking device 40 according to an embodiment. The locking device 40 includes a body portion 41 and a flange portion 47. The body portion 41 includes a first vertical portion 42 (also referred to as “first vertical leg”), a second vertical portion 43(also referred to as “second vertical leg”), and a horizontal portion 44 (also referred to as “horizontal leg”). More specifically, the first vertical leg 42 and the second vertical leg 43 can be configured such that the horizontal leg 44 has a width configured to substantially correspond to the width of a door (not shown in FIG. 6).

The flange portion 47 (also referred to herein as “flange”) is configured to extend perpendicularly from the first vertical leg 42. Similarly stated, the flange 47 can extend from a surface of the first vertical leg 42 such that at least a portion of the flange 47 is substantially parallel to the horizontal leg 44. The flange 47 can extend any suitable distance from the first vertical leg 42. For example, in some embodiments, the flange 47 can extend 1.25 inches from the first vertical leg 42. In other embodiments, the flange 47 can extend greater than 1.25 inches. In still other embodiments, the flange 47 can extend less than 1.25 inches. In yet other embodiments, the flange 47 can be configured to be adjustable such that the flange 47 can extend through a range of distances from the first vertical leg 42.

The flange 47 includes a vertical leg 47a configured to extend from the flange 47 in the vertical direction such that the vertical leg 47a is substantially parallel to the first vertical leg 42 (and/or the second vertical leg 43). For example, in some embodiments, the vertical leg 47a of the flange 47 can be mechanically bent (e.g., formed) such that the vertical leg 47a is substantially parallel to the first vertical leg 42 and/or the second vertical leg 43. The vertical leg 47a of the flange 47 includes an end portion 48 configured to extend beyond an end portion 45 (or end surface) of the body portion 41, as shown in FIG. 6. For example, in some embodiments, the end portion 48 of the vertical leg 47a can extend 0.5 inches beyond the end portion 45 of the body 41. In other embodiments, the end portion 48 can extend greater than 0.5 inches beyond the end portion 45 of the body 41. In still other embodiments, the end portion 48 can extend less than 0.5 inches beyond the end portion 45 of the body 41. In yet other embodiments, the end portion 48 can be configured to be adjustable such that the end portion 48 of the vertical leg 47a can extend through a range of distances from the end portion 45 of the body 41.

In this manner, a surface of the end portion 48 included in (or on) the vertical leg 47a can engage a structure adjacent to a door. Furthermore, the vertical leg 47a of the flange 47 has a height that is substantially less than the height of the first vertical leg 42 and/or the second vertical leg 43. Therefore, the vertical leg 47a of the flange portion 47 can engage a structure adjacent to the door that is parallel to a vertical edge of the door and not engage a structure adjacent to the door that is parallel to a horizontal edge of the door. Thus, the vertical leg 47a can engage the structure to selectively inhibit movement of the door, as described herein.

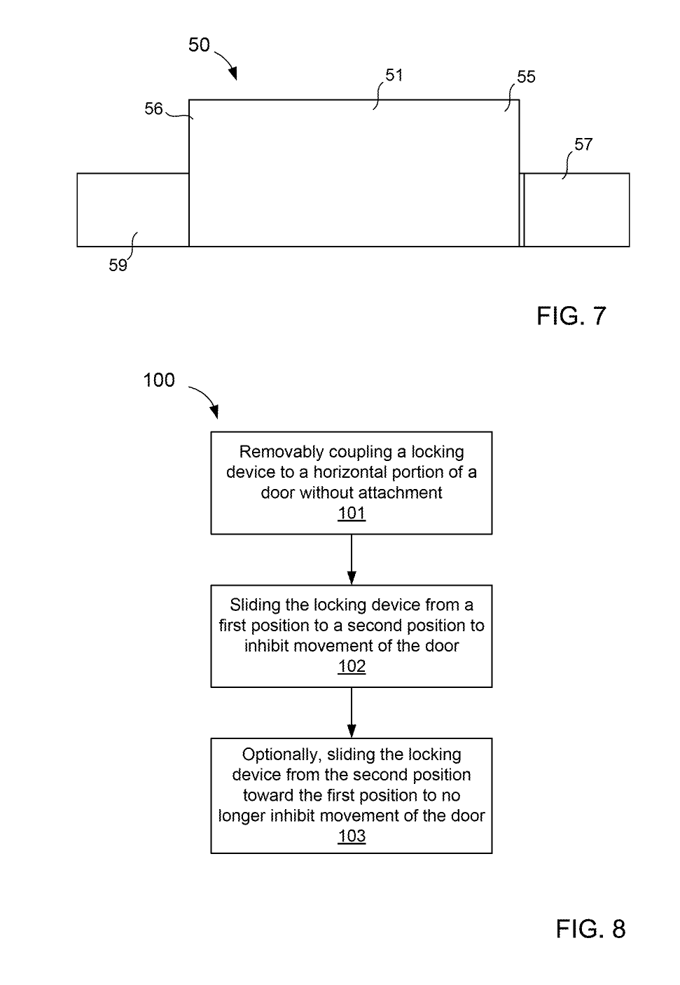

While the locking devices described above include a flange portion that extends from one end of a body portion, in some embodiments, a locking device can include more than one flange portion extending from a body portion. For example, FIG. 7 illustrates a locking device 50 according to an embodiment. The locking device 50 includes a body portion 51, a first flange portion 57, and a second flange portion 59. The body portion 51 can be substantially similar to those described herein. More specifically, the body portion 51 includes a first end portion 55 and a second end portion 56 from which the first flange portion 57 and the second flange portion 59 extend, respectively. In this manner, the locking device 50 can be configured to inhibit movement of a door as described above. Moreover, by including a first flange portion 57 and a second flange portion 59, the locking device 50 can engage a structure adjacent to a door regardless of the direction in which the door opens relative to the structure.

Referring now to FIG. 8, a flowchart illustrates a method 100 of selectively inhibiting movement of a door. The method 100 includes removably coupling a locking device to a horizontal portion (e.g., a top surface) of a door without attachment at 101. Expanding further, the locking device can be movably disposed about the door without mechanical attachment of the locking device to the door, as described herein. The locking device can be any suitable locking device described herein and thus, can include a body portion disposed about the door and a flange portion configured to selectively engage a structure adjacent to the door.

The method 100 further includes sliding the locking mechanism from a first position relative to the door (e.g., in which the flange portion is disposed between vertical edges of the door) to a second position relative to the door (e.g., in which the flange portion is disposed beyond a vertical edge of the door) to inhibit movement of the door at 102. More specifically, the locking device can be moved to the second position such that the flange portion engages the structure adjacent to the door, thus inhibiting movement of the door. In some embodiments, the method 100 can optionally include sliding the locking device from the second position toward the first position such that the flange portion no longer engages the structure adjacent to the door and thus, no longer inhibits movement of the door at 103.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above

Where schematics and/or embodiments described above indicate certain components arranged in certain orientations or positions, the arrangement of components may be modified. While the embodiments have been particularly shown and described, it will be understood that various changes in form and details may be made. For example, while the horizontal portion of the flange 47 is shown in FIG. 6 as having the same length as the first vertical leg 42, the second vertical leg 43, and the horizontal leg 44 of the body portion 41, any or all of the first vertical leg 42, the second vertical leg 43, and/or the horizontal leg 44 can have a length substantially greater than the horizontal portion of the flange 47. Said another way, the horizontal portion of the flange 47 can be configured to extend from a portion of the vertical leg 42. Similarly, while the first vertical leg 42, the second vertical leg 43, and the horizontal leg 44 of the body portion 41 are shown as having the same length, the first vertical leg 42, the second vertical leg 43, and/or the horizontal leg 44 can have any suitable length (e.g., need not be similar).

Although various embodiments have been described as having particular features and/or combinations of components, other embodiments are possible having a combination of any features and/or components from any of embodiments as discussed above.

1. An apparatus, comprising:
a body portion having
a first vertical portion;
a second vertical portion;
a first horizontal portion coupled between the first vertical portion and the second vertical portion; and
a second horizontal portion coupled to the first vertical portion and extending in a direction opposite the first horizontal portion, the body portion configured to slidably engage a horizontal portion of a door; and
a flange coupled to the second horizontal portion, the flange extending away from the second horizontal portion such that it is configured to engage at least a portion of a structure adjacent to the door.

2. The apparatus of claim 1, wherein the second horizontal portion has a first width and the flange has a second width, the second width being different from the first width, the flange extends past an edge of the body portion.

3. The apparatus of claim 1, wherein a length of the flange is substantially the same as a width of the structure adjacent the door.

4. The apparatus of claim 1, wherein the first vertical portion is configured to engage a first vertical surface of the door and the second vertical portion is configured to engage a second vertical surface of the door.

5. (canceled)

6. The apparatus of claim 1, the body portion and the flange being configured to inhibit movement of the door without being physically attached to the door or the structure adjacent to the door.

7. The apparatus of claim 1, further comprising a second flange coupled to the body portion at an end opposite the first flange.

8. The apparatus of claim 1, wherein the body portion and the flange are a monolithic construction.

9. The apparatus of claim 1, wherein the apparatus is configured to move between a first configuration in which the flange is positioned in an area between opposite vertical edges of the door and a second configuration in which the flange extends past one of the vertical edges of the door.

10. The apparatus of claim 1, further comprising a second flange coupled to the body portion adjacent a side opposite the first flange.

11. An apparatus, comprising:
a body portion having
a first vertical portion configured to engage a first side of a door,
a second vertical portion configured to engage a second side of the door, and
a first horizontal portion coupled between the first vertical portion and the second vertical portion, the horizontal portion configured to engage a horizontal portion of the door
a second horizontal portion coupled to the first vertical portion; and
a flange portion coupled to the second horizontal portion and extending past an edge of the body portion, the flange portion configured to engage a structure adjacent a vertical edge of the door when the door is in a completely closed position.

12. The apparatus of claim 11, wherein the flange is monolithically formed with the second horizontal portion.

13. The apparatus of claim 11, wherein the flange is configured to be movable with respect to the second horizontal portion.

14. The apparatus of claim 11, wherein the horizontal portion of the body portion has a width, the width being adjustable such that a distance between the first vertical portion and the second vertical portion is adjustable.

15. The apparatus of claim 11, further comprising a second flange coupled to the body portion, the first flange being coupled to the second horizontal portion at one end of the body portion, the second flange being coupled to an opposite edge of the body portion.

16. The apparatus of claim 11, wherein the apparatus is configured to move between a first position in which the flange does not engage the structure and a second position in which the flange engages the structure.

17. The apparatus of claim 11, wherein the apparatus is configured to be removably coupled to the door without physical attachment.

18. A method, comprising:
removably coupling without attachment to a horizontal surface of a door, a device having a body portion and a flange portion, the body portion having a first horizontal portion and a second horizontal portion, the flange portion being coupled to the second horizontal portion and disposed laterally apart from the first horizontal portion; and
sliding the device from a first position in which the device does not inhibit movement of the door to a second position in which the flange portion of the device engages a structure adjacent to the door, thereby inhibiting movement of the door.

19. The method of claim 18, further comprising sliding the device from the second position in the direction of the first position such that the flange portion no longer inhibits movement of the door.

20. The method of claim 18, wherein the removably coupling includes placing the device on the door without mechanical attachment of the device to the door.
